(19) United States
(12) Patent Application Publication
(10) Pub. No.: US 2025/0377764 A1
(43) Pub. Date: Dec. 11, 2025

(54) PAGE CONTROL METHOD AND APPARATUS, AND ELECTRONIC DEVICE

(71) Applicant: VIVO MOBILE COMMUNICATION CO., LTD., Dongguan (CN)

(72) Inventor: Ruochu LIU, Dongguan (CN)

(73) Assignee: VIVO MOBILE COMMUNICATION CO., LTD., Dongguan (CN)

(21) Appl. No.: 19/301,086

(22) Filed: Aug. 15, 2025

Related U.S. Application Data
(63) Continuation of application No. PCT/CN2024/076516, filed on Feb. 7, 2024.

(30) Foreign Application Priority Data
Feb. 17, 2023 (CN) 202310127879.5

(51) Int. Cl. G06F 3/0483; G06F 3/0354

(52) U.S. Cl. CPC G06F 3/0483; G06F 3/03547

(57) ABSTRACT

This application discloses a page control method and apparatus, and an electronic device. The method includes: obtaining a page touch operation instruction; controlling, in response to the page touch operation instruction, display of a target page triggered by the page touch operation instruction on a target electronic device among N first electronic devices based on an indication state of a device pointer array, where the device pointer array includes device pointers of the N first electronic devices, each device pointer is used to indicate a display page of a corresponding first electronic device, and N is a positive integer greater than 1.

### CROSS-REFERENCE TO RELATED APPLICATIONS

This application is a continuation application of PCT International Application No. PCT/CN2024/076516 filed on Feb. 7, 2024, which claims priority to Chinese Patent Application No. 202310127879.5, filed on Feb. 17, 2023, which is incorporated herein by reference in its entirety.

### TECHNICAL FIELD

This application pertains to the field of communication technologies, and specifically relates to a page control method and apparatus, and an electronic device.

### BACKGROUND

Foldable-screen electronic devices, due to their multiple screens that allow for split-screen display of applications, have gained popularity among consumers. The split-screen technologies of the related art are primarily applied to large-screen devices such as foldable screen devices and tablets, focusing on single-device implementations. However, when a user possesses multiple devices and desires a split-screen experience similar to that of a foldable screen, the related art is unable to meet this demand.

### SUMMARY

Embodiments of this application are intended to provide a page control method and apparatus, and an electronic device.

According to a first aspect, an embodiment of this application provides a page control method, including:
obtaining a page touch operation instruction; and
controlling, in response to the page touch operation instruction, display of a target page triggered by the page touch operation instruction on a target electronic device among N first electronic devices based on an indication state of a device pointer array, where the device pointer array includes device pointers of the N first electronic devices, each device pointer is used to indicate a display page of a corresponding first electronic device, and N is a positive integer greater than 1.

According to a second aspect, an embodiment of this application provides a page control apparatus, including:
an obtaining module configured to obtain a page touch operation instruction; and
a page control module configured to control, in response to the page touch operation instruction, display of a target page triggered by the page touch operation instruction on a target electronic device among N first electronic devices based on an indication state of a device pointer array, where the device pointer array includes device pointers of the N first electronic devices, each device pointer is used to indicate a display page of a corresponding first electronic device, and Nis a positive integer greater than 1.

According to a third aspect, an embodiment of this application provides an electronic device, where the electronic device is a first electronic device, the electronic device includes a processor and a memory, the memory stores a program or instructions capable of running on the processor, and when the program or instructions are executed by the processor, steps of the page control method according to the first aspect are implemented.

According to a fourth aspect, an embodiment of this application provides a readable storage medium, where a program or instructions are stored on the readable storage medium, and when the program or instructions are executed by a processor, steps of the page control method according to the first aspect are implemented.

According to a fifth aspect, an embodiment of this application provides a chip, where the chip includes a processor and a communication interface, the communication interface is coupled to the processor, and the processor is configured to run a program or instructions to implement the page control method according to the first aspect.

According to a sixth aspect, an embodiment of this application provides a computer program product, where the program product is stored in a storage medium, and the program product is executed by at least one processor to implement the page control method according to the first aspect.

### BRIEF DESCRIPTION OF DRAWINGS

FIG. 1 is a schematic flowchart of a page control method according to an embodiment of this application;

FIG. 2 is a first schematic diagram of operations for wireless connection of multiple devices according to an embodiment of this application;

FIG. 3 is a second schematic diagram of operations for wireless connection of multiple devices according to an embodiment of this application;

FIG. 4 is a third schematic diagram of operations for wireless connection of multiple devices according to an embodiment of this application;

FIG. 5 is a schematic diagram of a Bluetooth connection topology structure between a master controller and slave controllers after cascading is established according to an embodiment of this application;

FIG. 6 is a schematic diagram of operations for displaying a page on a front end of a master controller according to an embodiment of this application;

FIG. 7 is a first schematic diagram of operations for adding a new page on a device according to an embodiment of this application;

FIG. 8 is a second schematic diagram of operations for adding a new page on a device according to an embodiment of this application;

FIG. 9 is a third schematic diagram of operations for adding a new page on a device according to an embodiment of this application;

FIG. 10 is a fourth schematic diagram of operations for adding a new page on a device according to an embodiment of this application;

FIG. 11 is a fifth schematic diagram of operations for adding a new page on a device according to an embodiment of this application;

FIG. 12 is a sixth schematic diagram of operations for adding a new page on a device according to an embodiment of this application;

FIG. 13 is a schematic diagram illustrating page data types of page data sent from a master controller to a slave controller according to an embodiment of this application;

FIG. 14 is a first schematic diagram illustrating a slave controller displaying page data of a text content file type according to an embodiment of this application;

FIG. 15 is a second schematic diagram illustrating a slave controller displaying page data of a text content file type according to an embodiment of this application;

FIG. 16 is a schematic diagram illustrating a slave controller displaying page data of a multimedia file type according to an embodiment of this application;

FIG. 17 is a schematic diagram illustrating a slave controller displaying page data of an interactive control file type according to an embodiment of this application;

FIG. 18 is a first schematic diagram of operations for deleting a page on a device according to an embodiment of this application;

FIG. 19 is a second schematic diagram of operations for deleting a page on a device according to an embodiment of this application;

FIG. 20 is a first schematic diagram of operations for switching a page on a device according to an embodiment of this application;

FIG. 21 is a second schematic diagram of operations for switching a page on a device according to an embodiment of this application;

FIG. 22 is a schematic diagram of modules of a page control apparatus according to an embodiment of this application;

FIG. 23 is a schematic structural diagram of an electronic device according to an embodiment of this application; and

FIG. 24 is a schematic diagram of a hardware structure of an electronic device according to an embodiment of this application.

### DESCRIPTION OF EMBODIMENTS

The technical solutions in the embodiments of this application will be clearly described below with reference to the drawings in the embodiments of this application. It is apparent that the described embodiments are only a part of the embodiments of this application, and not all of them. All other embodiments obtained by a person of ordinary skill in the art based on the embodiments in this application fall within the protection scope of this application.

The terms “first”, “second”, and the like in the specification and claims of this application are used to distinguish similar objects and are not used to describe a specific order or sequence. It should be understood that the data so used may be interchanged under appropriate circumstances so that the embodiments of this application can be implemented in an order other than those illustrated or described herein, and generally the objects distinguished by “first”, “second”, and the like are of the same type without limiting the number of objects, for example, there may be one or more first objects. In addition, “and/or” in the specification and claims indicates at least one of the connected objects, and the character “/” generally indicates an “or” relationship between the associated objects.

The page control method provided in the embodiments of this application will be described in detail below through specific embodiments and their application scenarios with reference to the drawings.

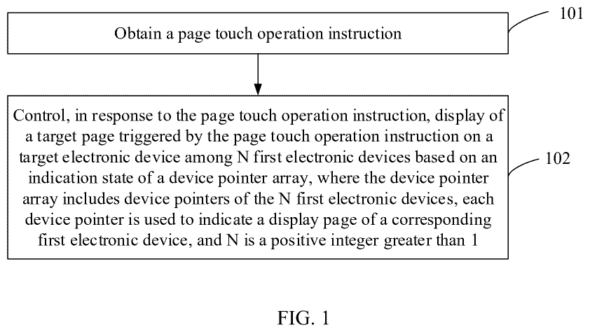

FIG. 1 is a schematic flowchart of a page control method according to an embodiment of this application. The method may specifically include the following steps.

Step 101. Obtain a page touch operation instruction.

Herein, the page touch operation instruction includes, but is not limited to, an add page instruction, a delete page instruction, and a switch page instruction.

Step 102. Control, in response to the page touch operation instruction, display of a target page triggered by the page touch operation instruction on a target electronic device among N first electronic devices based on an indication state of a device pointer array, where the device pointer array includes device pointers of the N first electronic devices, each device pointer is used to indicate a display page of a corresponding first electronic device, and N is a positive integer greater than 1.

It should be noted that the N first electronic devices are communicatively connected, specifically, the N first electronic devices are cascaded in a wired or wireless manner. The wireless manner includes, but is not limited to, a cellular mobile network, Wi-Fi, Bluetooth, NFC, or the like.

Herein, the page touch operation instruction may originate from any one of the N first electronic devices. It should be noted that the method embodiments of this application are executed by the first electronic device serving as a master control device among the N first electronic devices.

Step 101 may specifically include: in a case that a device is determined as the master control device, obtaining the page touch operation instruction through a communication connection of the N first electronic devices.

In an optional embodiment, before a device is determined as the master control device, the method of this application may further include the following steps.

(a1) Receive a first input that is performed on a first application icon.

Optionally, the first application icon is an application icon of a first application, where the first application is used to implement device cascading control, for example, the first application may be referred to as “device cascading control” software. The first application is installed on each of the N first electronic devices, and the first application icon is displayed on a desktop of each first electronic device.

Optionally, the first input is a preset input, and the first input may include, but is not limited to, at least one of a tap input, a press input, a touch-and-hold input, a pinch input, a drag input, a slide input, and a swipe input, meaning that the first input may be one of the above inputs or a combination of two or more of the above inputs.

(a2) In response to the first input, display a first window, where the first window includes a first functional component.

It should be noted that the first window is an initialization window of the first application. Optionally, the first functional component is a first virtual button, which is a button used to designate a master controller.

(a3) Receive a second input that is performed on the first functional component.

Optionally, the second input is a preset input, and the second input may include, but is not limited to, at least one of a tap input, a press input, a touch-and-hold input, a pinch input, a drag input, a slide input, and a swipe input, meaning that the second input may be one of the above inputs or a combination of two or more of the above inputs.

(a4) Determine, in response to the second input, the first electronic device executing the method as the master control device.

The determining the first electronic device executing the method as the master control device indicates that the first electronic device executing the method is a master control end for split-screen application display among the N first electronic devices, to which the other N−1 first electronic devices subsequently establish communication connections are all slave control devices. Page operations by a user on the other first electronic devices need to be reported to the master control device, meaning that the master control device can be aware of the page operations performed by the user on the other slave control devices, allowing cascading display of pages across the N first electronic devices through the master control device.

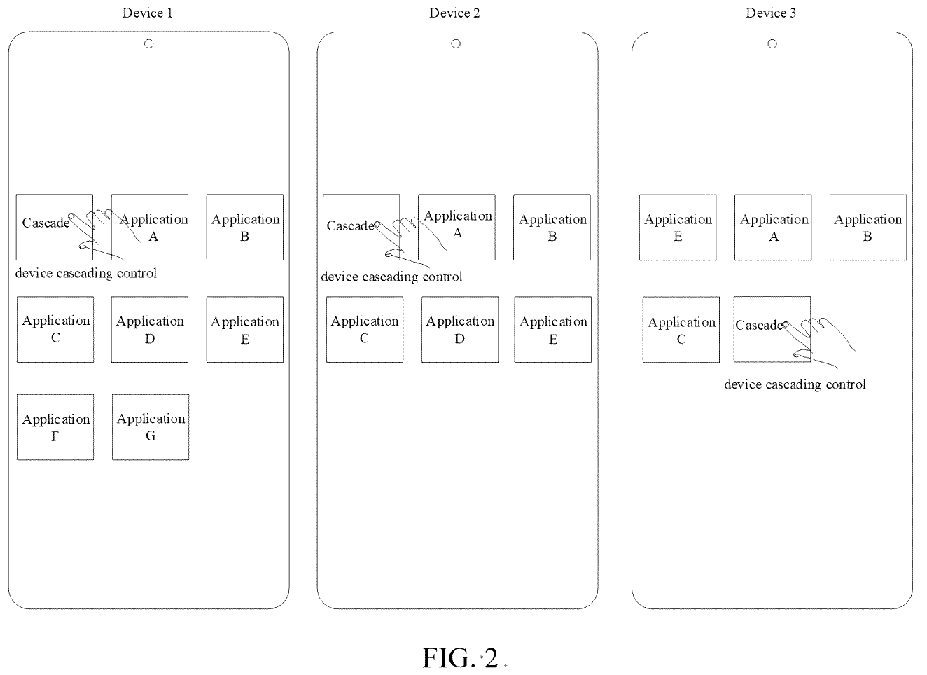

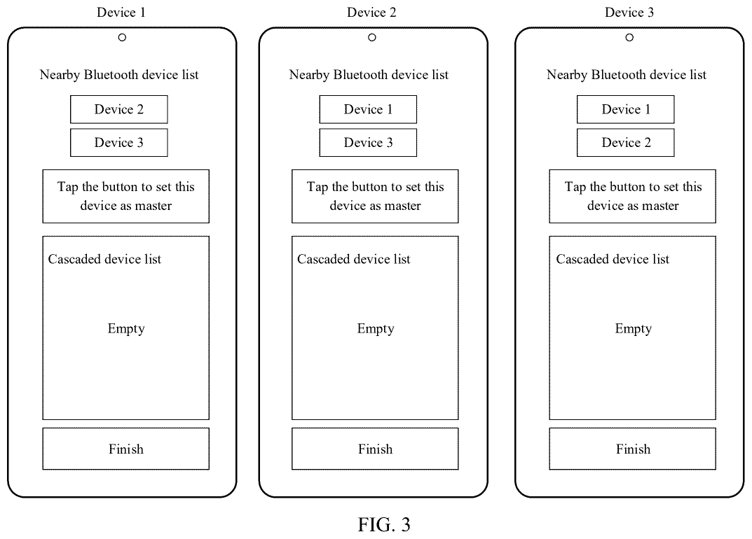

In Example 1, multiple devices separately receive a tap input by the user on application icon 1 of the “device cascading control” software, as shown in FIG. 2, meaning the user opens the “device cascading control” software on multiple devices. Then, each device enables Bluetooth connection and scans for nearby Bluetooth devices, while each device displays an initialization window 2 (that is, the first window) displayed by tapping the “device cascading control” software, as shown in FIG. 3. The initialization window 2 includes:
(1) a nearby Bluetooth device list: displays names of scanned nearby Bluetooth devices, each device being represented by a draggable device icon;
(2) a “set this device as master” button (that is, the first functional component): the user can tap this button to designate the current device as the master controller;
(3) a cascaded device list: displays the names and order of cascaded devices; and
(4) a finish button: after initialization is complete, the user taps this button to exit initialization.

Next, Device 1 receives a tap input that is performed on the “set this device as master” button from the user and designates Device 1 as the master controller.

In other words, the user selects one device and taps “set this device as master” to designate that device as the master controller, while other devices are designated as slave controllers by default. In this example, the master controller is the master control device, and the slave controllers are the slave control devices.

Further, the first window further includes: a first area and a second area, where the first area is used to display device icons of connectable devices, and the second area is used to display device icons of connected devices.

For example, the first area is an area where the nearby Bluetooth device list is located in FIG. 3, and the second area is an area where the cascaded device list is located in FIG. 3.

Correspondingly, after the determining, in response to the second input, the first electronic device executing the method as the master control device, the method of this application further includes the following steps.

(b1) Receive a third input that is performed on a device icon in the first area.

Optionally, the third input is a preset input, and the third input may include, but is not limited to, at least one of a tap input, a press input, a touch-and-hold input, a pinch input, a drag input, a slide input, and a swipe input, meaning that the third input may be one of the above inputs or a combination of two or more of the above inputs.

(b2) In response to the third input, display the device icon in the second area and establish a communication connection to the first electronic device corresponding to the device icon.

Herein, through the third input, the device icon in the first area (that is, a device icon of a connectable device) is moved to the second area, thereby achieving the purpose of the user selecting a desired device to be cascaded and establishing a wireless connection to this device.

(b3) Determine a device cascading order of the N first electronic devices, where the master control device is the first in the device cascading order, and a rank number of the device icon of each first electronic device in the second area plus 1 corresponds to its position in the device cascading order, where the device cascading order is a rank order of the device pointers of the N first electronic devices.

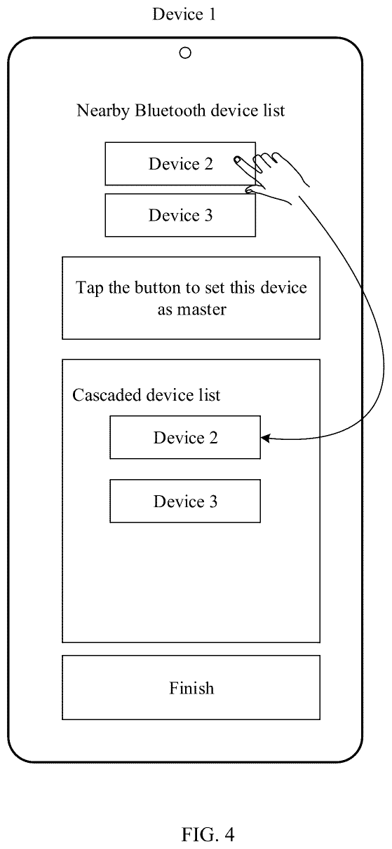

In Example 1, after Device 1 is designated as the master controller, the master controller receives a drag input from the user for dragging a device icon from the “nearby Bluetooth device list” to the “cascaded device list”, as shown in FIG. 4. Additionally, a device pointer array is initialized in a memory of the master controller, each device pointer representing one cascaded device, and the rank order of the device pointers in the device pointer array is consistent with the order in which the user drags and arranges the icons. Finally, the master controller receives a tap input on the “finish button” from the user, and the master controller establishes Bluetooth connections to the devices in the “cascaded device list”.

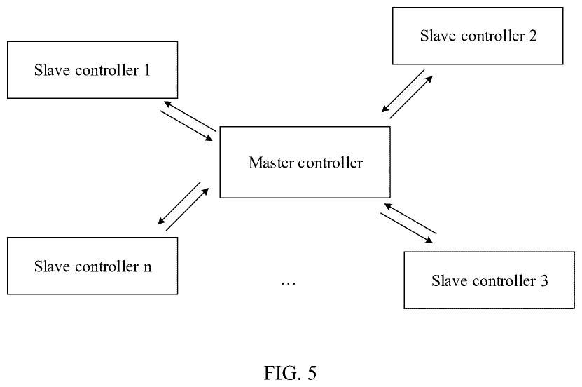

It should be noted that a topology structure of Bluetooth connections between the master controller and the slave controllers after cascading is complete is shown in FIG. 5.

The page control method in the embodiments of this application can implement split-screen application display across multiple electronic devices, satisfying the user requirement for split-screen functionality across multiple devices.

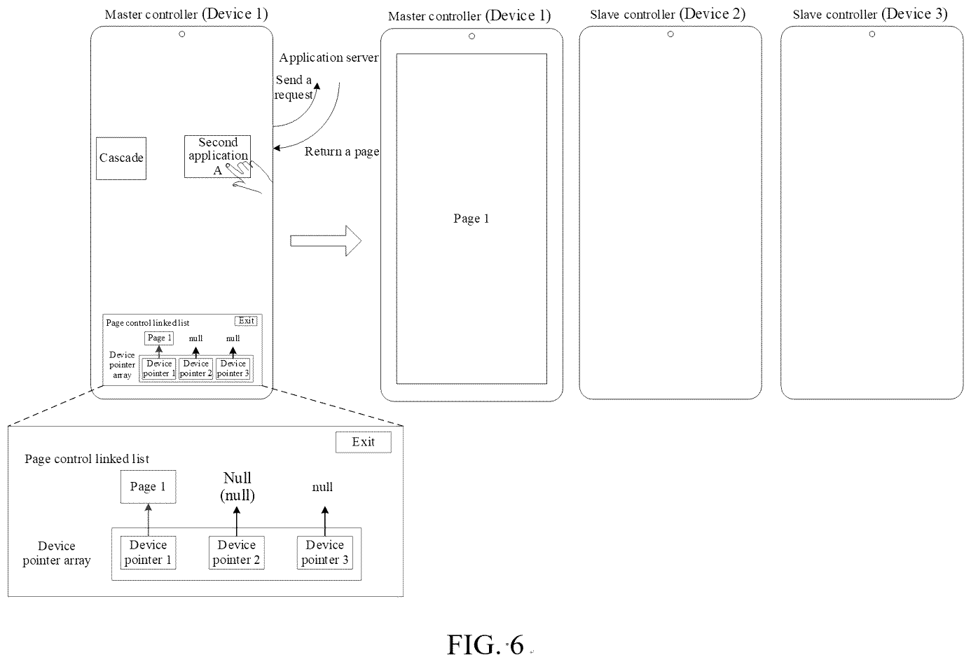

In an optional example, after the N first electronic devices are cascaded, as shown in FIG. 6, the device pointer array is displayed on the master control device. Further, a page control linked list is also displayed on the master control device, where the page control linked list is initially an empty linked list, including page nodes for storing memory addresses of page data, where the page nodes reflect display pages of the corresponding first electronic devices indicated by the device pointers. It should be understood that in a case that a page node pointed to by one device pointer does not store a memory address of page data, it indicates that no page is displayed on a terminal corresponding to that device pointer; and in a case that a page node pointed to by one device pointer stores a memory address of page data, it indicates that a page corresponding to the page data is displayed on a terminal corresponding to that device pointer.

Herein, as shown in FIG. 6, in addition to displaying the device pointer array and the page control linked list, the master control device also displays an exit button for subsequently exiting the device cascading state.

Through the visualization of the device pointer array as shown in FIG. 6, the user can easily understand the page display status of the first electronic devices with established communication connections by viewing it.

In Example 2, as shown in FIG. 6, the master controller receives a tap input that is performed on a second application A (for example, the second application A is a news application (APP)) from the user. Through the second application A, the master controller sends a page request to a corresponding application server; and the master controller receives page data returned by the application server based on the page request, and displays a page corresponding to the page data on the front end of the master controller.

Then, the master controller creates a page node in the page control linked list to store the page data received from the application server for the initial request, and names it “Page 1”, as shown in FIG. 6. The master controller changes a memory address of page data corresponding to a page node pointed to by device pointer 1 (the device pointer corresponding to Device 1) from “null” after initialization to the memory address of “Page 1”. Device pointer 2 (the device pointer corresponding to Device 2) and device pointer 3 (the device pointer corresponding to Device 3) remain pointing to null, that is, front ends of slave controller1 (Device 2) and slave controller2 (Device 3) display the desktop.

In an optional embodiment, Step 102 may include the following steps.

Step 1021a. In a case that the page touch operation instruction is an add application page instruction, obtain, in response to the add application page instruction, a new application page corresponding to the add application page instruction.

Herein, the add application page instruction may originate from the master control device (the first electronic device executing the method embodiments of this application). For example, the master control device obtains a tap input that is performed on a target link on a first page thereon from the user, where an instruction generated corresponding to this tap input is the add application page instruction, which should be understood as an instruction for requesting to display a next-level page of the first page.

Certainly, the add application page instruction may alternatively originate from other first electronic devices (other slave control devices) different from the master control device among the N cascaded first electronic devices. In this case, the master control device obtains the add application page instruction from the other first electronic devices (other slave control devices) through the communication connection between the devices.

Specifically, in response to the add application page instruction, the master control device sends a page request message corresponding to the add application page instruction to the application server; and then, the master control device receives the new application page returned by the application server based on the page request message.

Step 1022a. Control display of the new application page on the target electronic device based on an indication state of a first device pointer corresponding to a second electronic device that generates the add application page instruction and an arrangement order of the device pointers of the N first electronic devices, where the second electronic device is one of the N first electronic devices.

The specific implementation of Step 1022a is described below in different scenarios. In an optional embodiment, Step 1022a may specifically include:
in a case that the first device pointer indicates that a front-end display page of the second electronic device is a first application page, and that a second device pointer ranked after the first device pointer exists in the device pointer array, determining a first electronic device corresponding to the second device pointer as the target electronic device, where the second device pointer indicates that a front-end display page of the target electronic device is a main page or a second application page, and the second application page is an application page of a same level as the new application page; and controlling display of the new application page on the target electronic device, where the new application page is a next-level application page of the first application page.

After Step 1022a, the indication state of the device pointer array is updated; and based on the updated indication state of the device pointer array, a front-end display page of an electronic device to be updated is updated.

In this case, that the indication state of the device pointer array is updated includes: causing the second device pointer to indicate that the front-end display page of the target electronic device is the new application page; and causing all device pointers ranked after the second device pointer in the device pointer array to indicate that their corresponding front-end display pages are the main page.

Herein, if the front-end display page of the first electronic device (target electronic device) indicated by the second device pointer is the main page, the main page is replaced with the new application page; and if the front-end display page of the first electronic device indicated by the second device pointer is the second application page, the second application page is replaced with the new application page.

If the second device pointer indicates that the front-end display page of the target electronic device is the main page, it indicates that the second electronic device is a last first electronic device with an application page displayed on the front end; and if the second device pointer indicates that the front-end display page of the target electronic device is the second application page, it indicates that the second electronic device is not the last first electronic device with an application page displayed on the front end.

Based on FIG. 6, an optional processing approach is as follows: First, determine, by judging whether a page node pointed to by the first device pointer is a last page node with a memory address of application page data stored, whether the second electronic device is the last first electronic device with an application page displayed on the front end; and if the judgment result is no, determine that the second electronic device is not the last first electronic device with an application page displayed on the front end; or if the judgment result is yes, determine that the second electronic device is the last first electronic device with an application page displayed on the front end.

Case 1: When it is determined that the second electronic device is not the last first electronic device with an application page displayed on the front end, after all page nodes following the page node pointed to by the first device pointer and page data corresponding to these page nodes are deleted, a new page node is added after the page node pointed to by the first device pointer, and a new application page is transmitted to the first electronic device (target electronic device) corresponding to the second device pointer. Additionally, the second device pointer points to the new page node, and the new page node stores a memory address corresponding to page data of the new application page.

It should be noted that after all page nodes following the page node pointed to by the first device pointer and the page data corresponding to these page nodes are deleted, a delete page data instruction is sent to the first electronic devices corresponding to these page nodes, causing the related first electronic devices to locally delete the currently displayed application page and display the main page instead.

In Example 3, as shown in FIG. 7, Device 2 (slave controller) receives a tap input that is performed on a target link on its front-end page (Page 2) from the user.

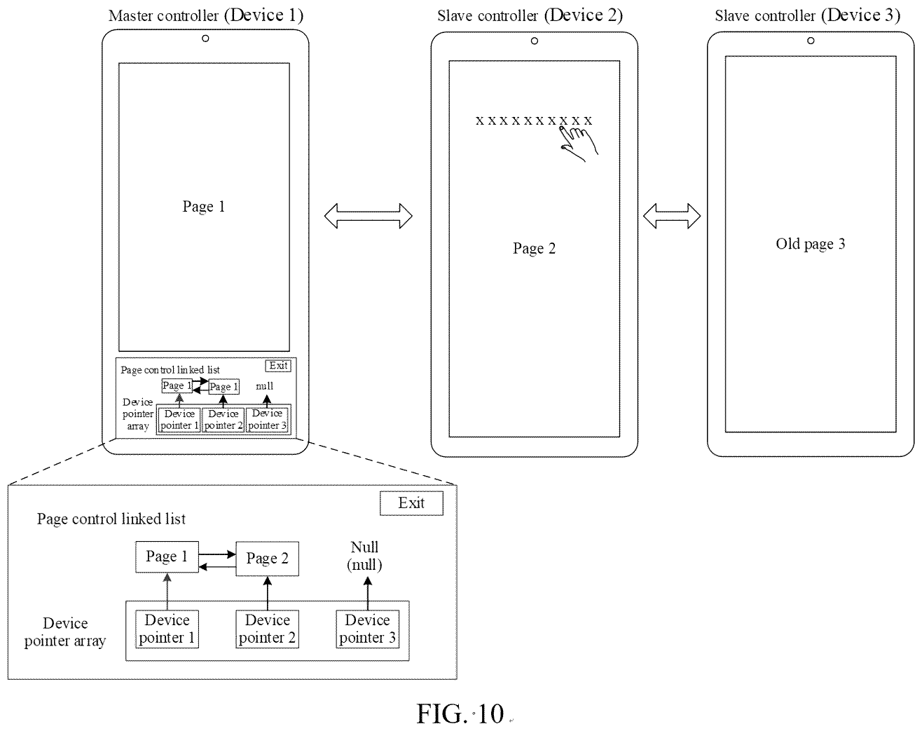

In response to the tap input, a page request parameter is obtained; and the page request parameter is transmitted to Device 1 (master controller) via a Bluetooth connection. As shown in FIG. 10, device cascading has been established between one master controller (Device 1) and two slave controllers, and the three devices sequentially display three pages. Now, Device 2 receives a tap input that is performed on a target link on its front-end page (Page 2) from the user.

After receiving the page request parameter transmitted by Device 2, Device 1 sends a page request message to the application server, the page request message carrying the page request parameter; and receives page data returned by the application server.

Then, Device 1 finds, through the device pointer array, the page node pointed to by the device pointer (device pointer 2) of the device being operated by the user; and deletes all page nodes following the page node pointed to by device pointer 2 in the page control linked list (that is, deletes the page node named Page 3); where the corresponding device pointer (device pointer 3) points to null. In this case, the page displayed on Device 3 corresponding to the device pointer (device pointer 3) pointing to null remains unchanged, that is, the previous page is still displayed, as shown in FIG. 10.

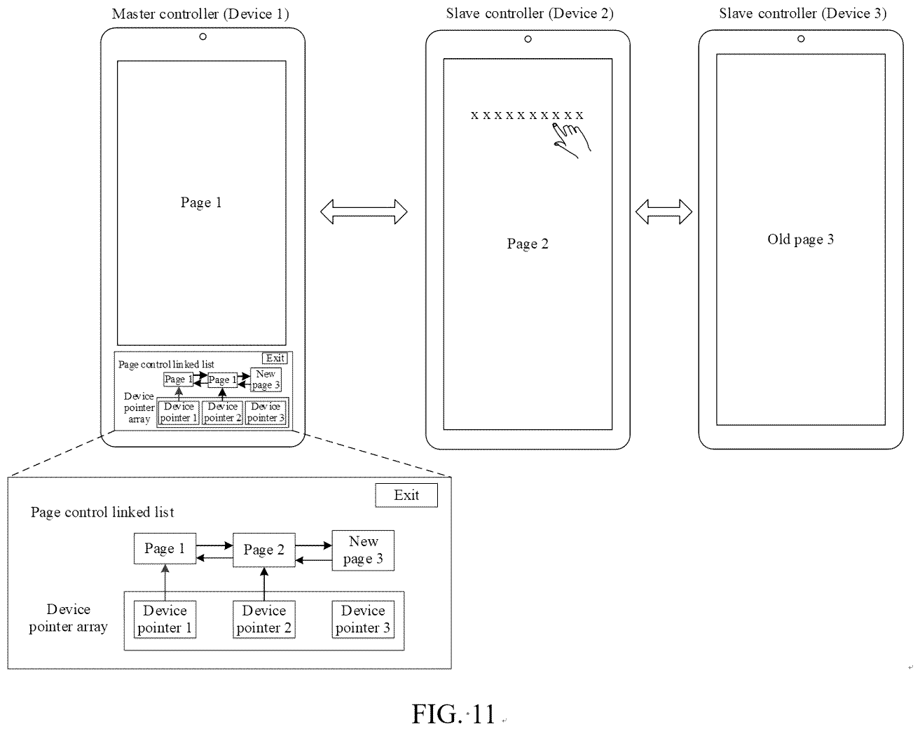

Then, Device 1 adds a new page node (named New page 3, as shown in FIG. 11) at a tail node of the page control linked list (that is, after the page node pointed to by device pointer 2 of Device 2) to store a memory address of the page data returned by the application server, where a memory space corresponding to the memory address stores the page data returned by the application server.

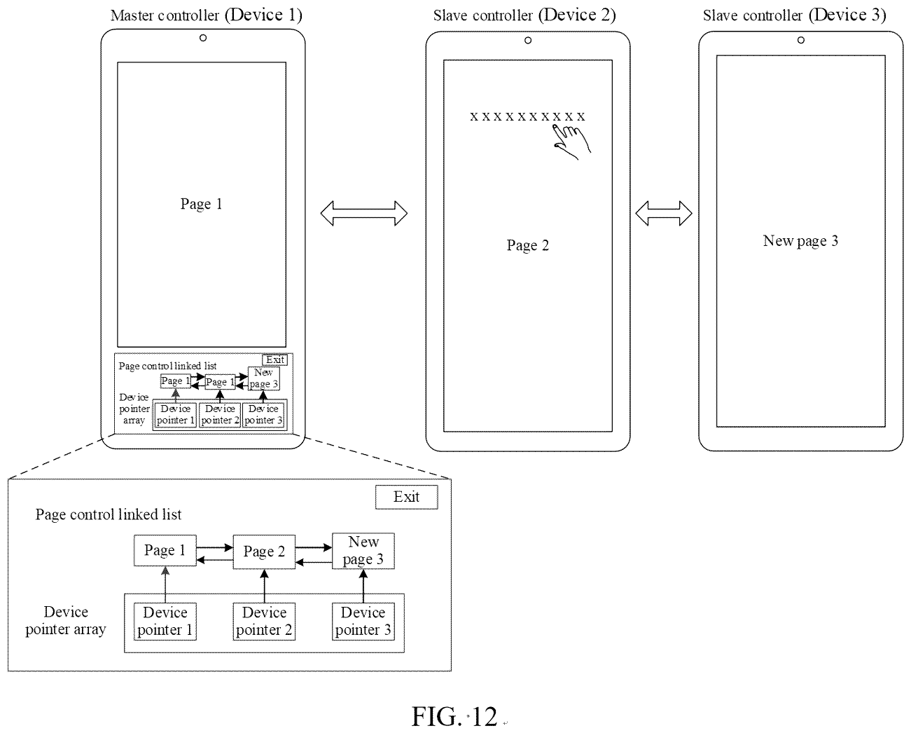

Then, Device 1 finds the device pointer (device pointer 3) following the device pointer operated by the user in the device pointer array, and sets device pointer 3 to point to the new page node, as shown in FIG. 12.

Finally, Device 1 transmits the page data returned by the application server to Device 3 corresponding to device pointer 3 via the Bluetooth connection, and Device 3 displays New page 3 corresponding to the page data at the front end, replacing the original Page 3.

Case 2: When it is determined that the second electronic device is a last first electronic device with an application page displayed at the front end, a new page node is added after the page node pointed to by the first device pointer, and the new application page is transmitted to the first electronic device (target electronic device) corresponding to the second device pointer. Additionally, the second device pointer points to the new page node, and the new page node stores a memory address corresponding to page data of the new application page.

In Example 4, Device 2 (slave controller) receives a tap input that is performed on a target link on its front-end page (the first page, or Page 2 in the figure) from the user.

In response to the tap input, a page request parameter is obtained; the page request parameter is transmitted to Device 1 (master controller) via a Bluetooth connection. After receiving the page request parameter transmitted by Device 2, Device 1 sends a page request message to the application server, the page request message carrying the page request parameter; and receives page data returned by the application server.

Then, the first device pointer pointing to null is found in the device pointer array, and a corresponding device (a second terminal, or Device 3 in FIG. 7) is obtained. In this case, Device 1 adds a new page node (named Page 3, as shown in FIG. 7) after a tail node of the page control linked list (that is, a page node (named Page 2 in FIG. 7) pointed to by device pointer 2 of Device 2) to store a memory address of the page data returned by the application server, where a memory space corresponding to the memory address stores the page data returned by the application server.

Finally, the page data returned by the application server is transmitted to Device 3 via the Bluetooth connection, and Device 3 displays a page (target page) corresponding to the page data on the front end, as shown in FIG. 7.

In another optional embodiment, Step 1022a may specifically include:
in a case that the first device pointer indicates that the front-end display page of the second electronic device is a first application page, and that the first device pointer is a last device pointer in the device pointer array, determining the second electronic device as the target electronic device; and controlling display of the new application page on the target electronic device, where the new application page is a next-level application page of the first application page.

After Step 1022a, the indication state of the device pointer array is updated; and based on the updated indication state of the device pointer array, afront-end display page of an electronic device to be updated is updated.

In this case, that the indication state of the device pointer array is updated includes: causing the first device pointer to indicate that the front-end display page of the target electronic device is the new application page; and causing all device pointers ranked before the first device pointer in the device pointer array to indicate that their corresponding front-end display pages are next-level pages of their original pages.

Based on FIG. 6, in this case, that is, the first device pointer indicates that the front-end display page of the second electronic device is a first application page, and the first device pointer is a last device pointer in the device pointer array, a new page node is added after the page node pointed to by the first device pointer, and each device pointer in the device pointer array is moved along a direction of the new page node to a next page node of the originally pointed page node. Additionally, the new application page is transmitted to the first electronic device (target electronic device) corresponding to the second device pointer, a next-level page of the original page is displayed on the local device, and page data of the next-level pages of the original pages corresponding to all first electronic devices except the second electronic device and the local device (the first electronic device serving as the master control device) is transmitted to the corresponding first electronic devices.

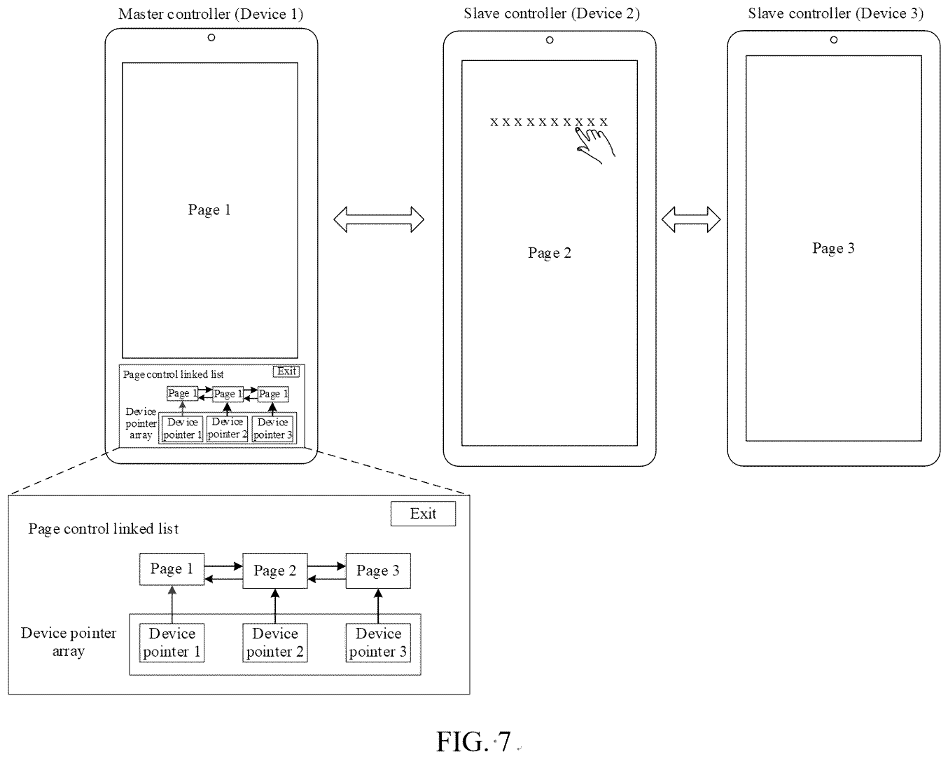

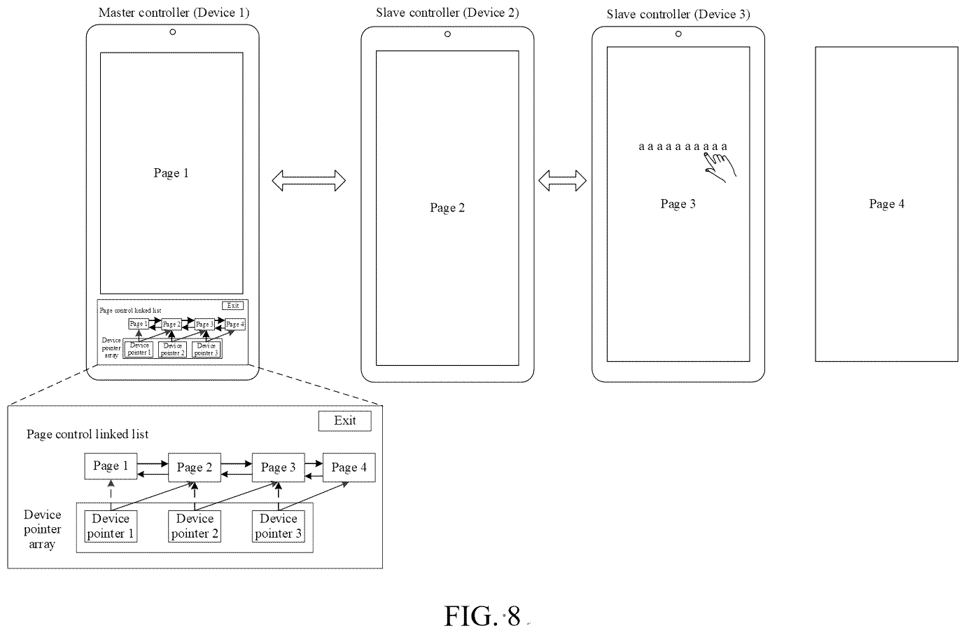

In Example 5, as shown in FIG. 8, Device 3 (slave controller) receives a tap input that is performed on a target link on its front-end page (Page 3) from the user.

In response to the tap input, a page request parameter is obtained; and the page request parameter is transmitted to Device 1 (master controller) via a Bluetooth connection. After receiving the page request parameter transmitted by Device 3, Device 1 sends a page request message to the application server, the page request message carrying the page request parameter; and receives page data returned by the application server.

Then, no device pointer pointing to null can be found in the device pointer array, meaning that no device pointer pointing to null exists in the device pointer array, and it is determined that Device 3 is the last device in the device pointer array. In this case, Device 1 adds a new page node (named Page 4, as shown in FIG. 8) after a tail node of the page control linked list (that is, a page node (named Page 3 in FIG. 8) pointed to by device pointer 3 of Device 3) to store a memory address of the page data returned by the application server, where a memory space corresponding to the memory address stores the page data returned by the application server.

Then, the memory address pointed to by each device pointer in the device pointer array is shifted by one page node toward a tail of the page control linked list, as shown in FIG. 8.

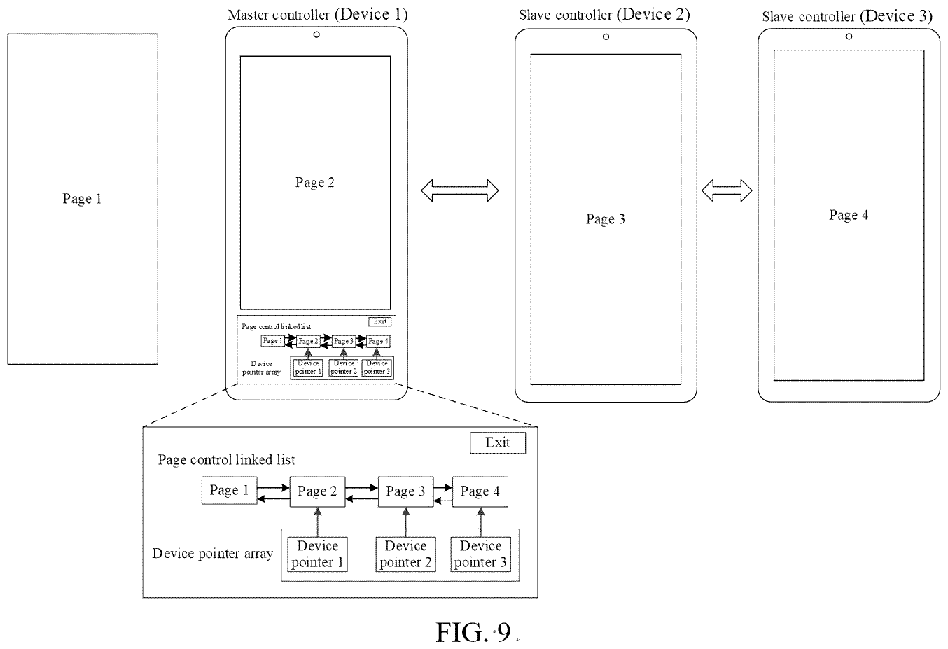

Finally, based on the page nodes pointed to by the updated device pointers, Device 1 transmits page data stored in the corresponding page nodes to the corresponding devices; and after receiving the data, these devices display pages on the front ends. In this example, Device 1 corresponding to device pointer 1 displays a next-level page of Page 1, that is, Page 2; Device 2 corresponding to device pointer 2 displays a next-level page of Page 2, that is, Page 3; and Device 3 corresponding to device pointer 3 displays a next-level page of Page 3, that is, Page 4, as shown in FIG. 9.

The various scenarios in the above embodiments all involve the master control device transmitting page data to at least one first electronic device (slave control device), excluding the master control device, among the N first electronic devices, that is, displaying pages on the slave controllers, where the page display is determined by the display parameter of each slave controller. Specifically:

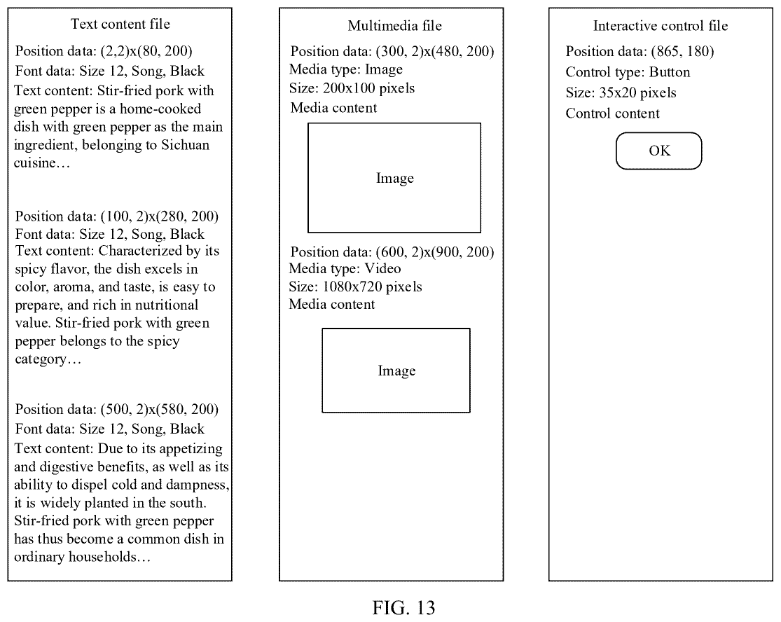

(1) The master controller sends page data to the slave controller, where the data includes three types of files: text content file, multimedia file (such as images and video), and interactive control file (such as buttons and icons), as shown in FIG. 13.

After receiving the page data, the slave controller stores these three types of files in the memory. When the screen size of the slave controller is insufficient to display all the data, only the displayable portion is displayed, and the non-displayable portion is read from the memory and displayed after the user scrolls the screen.

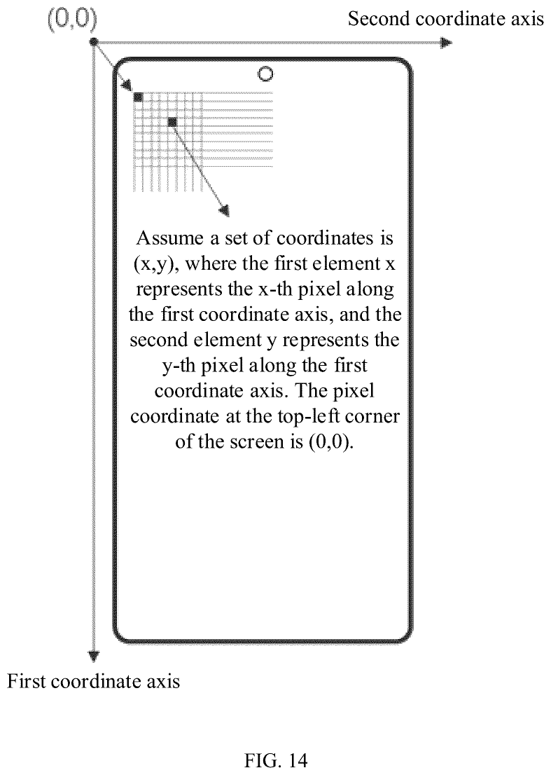

(2) First, the text content file is displayed, where the text content file includes multiple text blocks, and each text block contains position data, font data, and text content. The position data consists of two coordinates in pixels. A first set of coordinates in the position data is the position of a top-left corner point of a rectangular frame, and a second set of coordinates is the position of a bottom-right corner point of the rectangular frame. The first number in each set of coordinates is the pixel number on a first coordinate axis, and the second number is the pixel number on a second coordinate axis, as shown in FIG. 14.

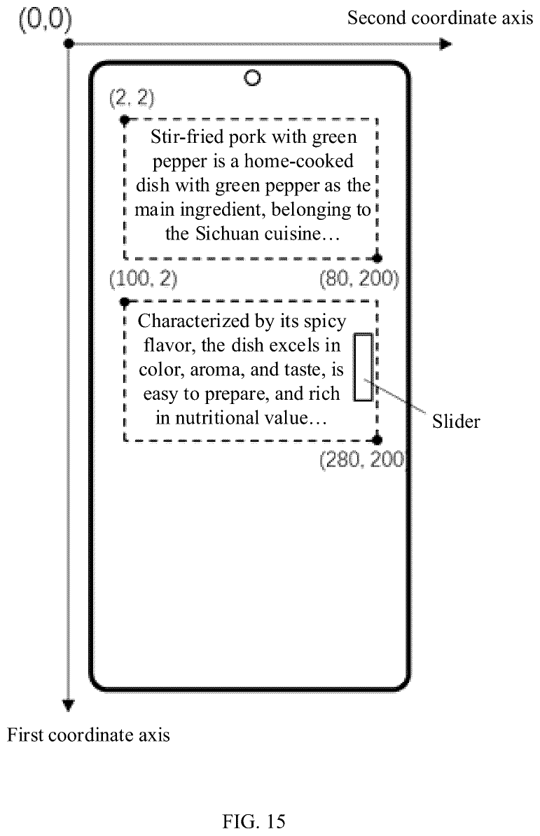

(a) On the phone screen, these two sets of position coordinates are used to frame a rectangle, and within the range of this rectangle, text content is displayed according to the font size, font, and color specified by the font data. If the text content is too much to fit within the rectangle, a slider is automatically added on the right side for scrolling the text content, as shown in FIG. 15.

(b) If the width of the rectangular frame exceeds the phone screen width, the second coordinate of the bottom-right corner point is adaptively changed to match the pixel value of the phone screen width.

(c) If the first coordinate axis coordinate of the bottom-right corner point of the rectangular frame exceeds the phone screen length, only the text content within the phone screen length is displayed, and the excess portion is read from the memory and displayed after the user scrolls the screen.

(3) Then, the multimedia file is displayed, where the multimedia file includes multiple media blocks, and each media block contains position data, media type, size data, and media content.

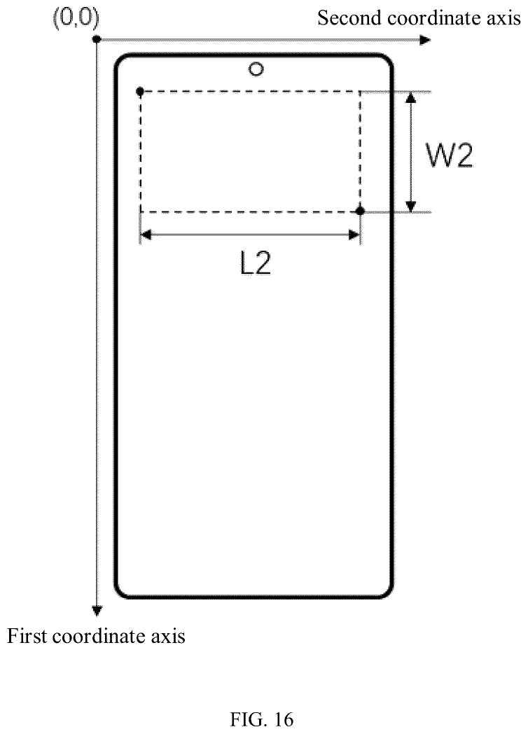

(a) First, as in step (1), a rectangular frame for displaying the multimedia is marked, as shown in FIG. 16.

(b) Then, a new thread for playing the multimedia is started based on the media type. For example, a player thread needs to be started for video or music media, while no new thread needs to be started for image media.

(c) The media size is adjusted to fit the screen range. The adjustment method is: letting the original media length be L1 and width be W1, and the rectangular frame length be L2 and width be W2, where the length refers to the number of pixels along the first coordinate axis, and the width refers to the number of pixels along the second coordinate axis.
calculating the values of L1/L2 and W1/W2, where if both the values of L1/L2 and W1/W2 are less than 1, it indicates that the media size is smaller than the rectangular frame, and the media is displayed centered in the rectangular frame; and
if the value of either L1/L2 or W1/W2 is greater than 1, comparing the values of L1/L2 and W1/W2; and if L1/L2>W1/W2, adjusting the media length to L1 and the media width to W1*L2/L1; or if L1/L2<W1/W2, adjusting the media length to L1*W2/W1 and the media width to W2.

(d) The resized multimedia is displayed centered in the rectangular frame.

(e) If the first coordinate axis coordinate of the bottom-right corner point of the rectangular frame exceeds the phone screen length, only the media content within the phone screen length is displayed, and the excess portion is read from the memory and displayed after the user scrolls the screen.

(4) Finally, the interactive control file is displayed, where each interactive control file includes multiple controls, and each control contains position data, control type, control size, and control content.

(a) The position data of a control includes only one set of coordinates, defined as (X, Y), which is the display coordinate of the top-left corner point of the control; the control size includes a set of dimensions, defined as (L, W), which are the numbers of pixels of the control along the first and second coordinate axes, respectively; and the phone screen width is defined as D.

(b) The control position is adjusted. When the width of the control along the second coordinate axis exceeds the screen width display range, that is, Y+L>D, the second coordinate of the position data is adjusted to D−L.

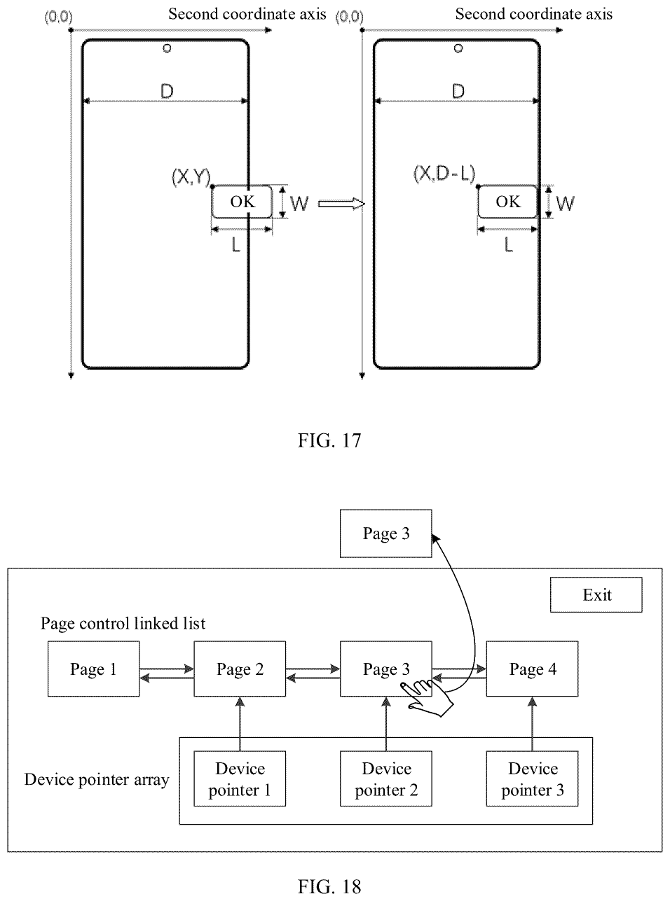

(c) The control content is displayed according to the adjusted control position coordinates, as shown in FIG. 17.

(d) If the first coordinate axis coordinate of the bottom-right corner point of the control exceeds the phone screen length, only the control content within the phone screen length is displayed, and the excess portion is read from the memory and displayed after the user scrolls the screen.

In this embodiment, in a case that the N first electronic devices are communicatively connected, addition of new pages to the devices allows each first electronic device to freely add pages, and allows the cascaded devices to adaptively display the newly added pages.

In another optional embodiment, Step 102 may specifically include the following steps.

Step 1021b. In a case that the page touch operation instruction is a delete application page instruction, determine a third application page corresponding to the delete application page instruction.

Specifically, the delete application page instruction is a delete application page instruction used by the user on the first electronic device executing the method (the first electronic device serving as the master control device).

Step 1022b. Update indication states of a third device pointer and all device pointers ranked after the third device pointer, obtain the updated indication states of the third device pointer and all device pointers ranked after the third device pointer, and determine the first electronic devices corresponding to the device pointers with the updated indication states as the target electronic devices, where the third device pointer is a device pointer corresponding to the third application page.

Herein, the updating indication states of the third device pointer and all device pointers ranked after the third device pointer includes: causing all device pointers ranked after the third device pointer in the device pointer array to indicate that their corresponding front-end display pages are the main page, and updating the indication state of the third device pointer based on the third application page. Specifically, if the third application page is the application home page, the update process is: causing the third device pointer to indicate that its corresponding front-end display page is the main page; or if the third application page is not an application home page, causing the third device pointer to indicate that its corresponding front-end display page is a previous-level application page of the third application page.

Step 1023b. Control, based on the updated indication states of all device pointers ranked after the third device pointer, display of the main page on the target electronic devices corresponding to the device pointers.

Step 1024b. In a case that the third application page is an application home page, control, based on the updated indication state of the third device pointer, display of the main page on the target electronic device corresponding to the third device pointer.

Step 1025b. In a case that the third application page is not an application home page, control, based on the updated indication state of the third device pointer, display of a previous-level application page of the third application page on the target electronic device corresponding to the third device pointer.

In this embodiment, based on FIG. 6, an optional processing approach is described: (I) In response to the delete application page instruction, mark the third device pointer and all device pointers ranked after the third device pointer in the device pointer array. (II) In a case that the third device pointer is not the device pointer of the first electronic device, or in a case that the third device pointer is the device pointer of the first electronic device and the page node corresponding to the third device pointer is ahead node in the page control linked list (that is, the third application page indicated by the third device pointer is the application home page), send a delete application page instruction to the first electronic devices corresponding to the marked device pointers, and delete the page node corresponding to the third device pointer, the page data of the third application page corresponding to this page node, all page nodes following this page node, and the page data corresponding to these page nodes.

In Example 6, Device 1 (master controller) receives a drag input that is performed on the page node named “Page 3” from the user, as shown in FIG. 18. When the user releases the finger after dragging the page node outside the control frame, a delete page operation is triggered.

Then, it is determined whether the page deleted by the user (that is, the third application page) is a page node pointed to by the device pointer corresponding to the slave controller or a page node pointed to by the device pointer corresponding to the master controller.

In this example, the page deleted by the user is a page node (named “Page 3”) pointed to by the device pointer corresponding to the slave controller.

Then, in Device 1, starting from the page node dragged by the user, the page control linked list is traversed toward the tail, and the device pointer corresponding to each page node is marked as “to be changed”.

Then, the memory addresses pointed to by the marked device pointers are changed to null.

Then, Device 1 sends a clear page instruction to the devices corresponding to the marked device pointers (Device 2 and Device 3 in this example) via the established Bluetooth connection. After receiving the clear page instruction, Device 2 and Device 3 display the desktop (main page) on their respective front ends.

Finally, in Device 1, starting from the page node dragged by the user, the page control linked list is traversed toward the tail, the page data correspondingly stored in each traversed page node is deleted, and these page nodes are removed from the page control linked list.

Alternatively, (III) in a case that the third device pointer is the device pointer of the first electronic device and the page node corresponding to the third device pointer is not the head node in the page control linked list (that is, the third application page indicated by the third device pointer is not the application home page), the third device pointer is pointed to the head node in the page control linked list, the application home page corresponding to the head node is displayed on the master control device, a clear page instruction is sent to all first electronic devices (that is, other slave control devices) corresponding to the marked device pointers except the master control device, and the page node corresponding to the third device pointer, the third application page corresponding to this page node, all page nodes following this page node, and the page data corresponding to these page nodes are deleted.

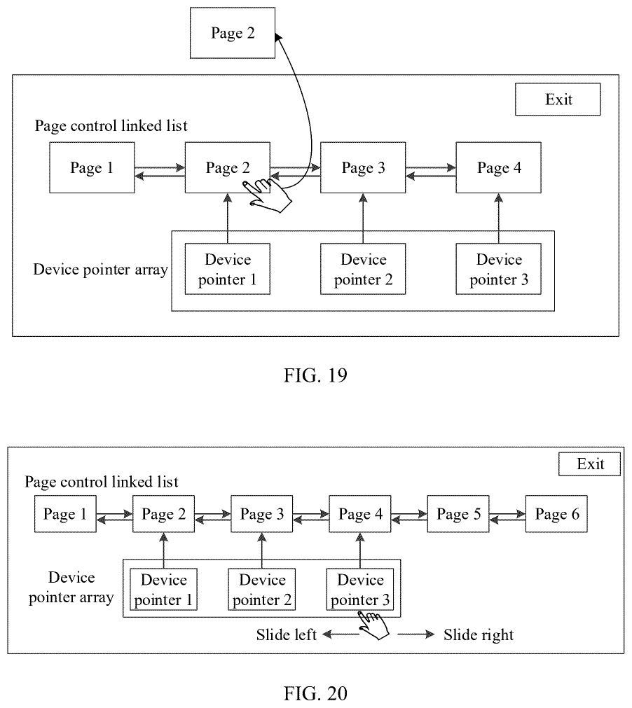

In Example 7, Device 1 (master controller) receives a drag input that is performed on the page node named “Page 2” from the user, as shown in FIG. 19. When the user releases the finger after dragging the page node outside the control frame, a delete page operation is triggered.

Then, it is determined whether the page deleted by the user is a page node pointed to by a device pointer corresponding to a slave controller or a page node pointed to by the device pointer corresponding to the master controller.

In this example, the page deleted by the user is a page node (named “Page 2”) pointed to by the device pointer corresponding to the master controller (Device 1).

Then, in Device 1, starting from the page node dragged by the user, the page control linked list is traversed toward the tail, and the device pointer corresponding to each page node is marked as “to be changed”.

Then, the memory addresses pointed to by the marked device pointers are changed to null.

Then, Device 1 determines whether the page node dragged by the user is ahead node of the page control linked list. If so, the device pointer corresponding to the master controller is pointed to null; if not so, the device pointer corresponding to the master controller is pointed to a previous node of the page node dragged by the user.

In this example, Device 1 determines that the page node dragged by the user is not the head node of the page control linked list, and points the device pointer corresponding to the master controller to the previous node of the page node dragged by the user, that is, the page node named Page 1. In other words, Device 1 subsequently displays a previous-level page of Page 2, that is, Page 1.

Then, Device 1 sends a clear page instruction to the slave controllers corresponding to the marked device pointers (Device 2 and Device 3 in this example) via the established Bluetooth connection. After receiving the clear page instruction, Device 2 and Device 3 display the desktop (main page) on their respective front ends.

Finally, in Device 1, starting from the page node dragged by the user, the page control linked list is traversed toward the tail, the page data correspondingly stored in each traversed page node is deleted, and these page nodes are removed from the page control linked list.

In this embodiment, in a case that the N first electronic devices are communicatively connected, deletion of pages from the devices allows the cascaded devices to implement adaptive display after page deletion.

In yet another optional embodiment, Step 102 may specifically include the following steps.

Step 1021c. In a case that the page touch operation instruction is an operation instruction for the device pointer array, update, in response to the page touch operation instruction, the indication state of the device pointer array according to an operation direction in the page touch operation instruction.

Specifically, the operation instruction for the device pointer array is an operation instruction used by the user on the first electronic device executing the method (the first electronic device as the master control device) for the device pointer array.

Step 1022c. Update, based on the updated indication state of the device pointer array, the front-end display pages of the first electronic devices.

It should be understood that the operation instruction used by the user for the device pointer array on the master control device is a switch page instruction.

Specifically, the master control device obtains the operation instruction used by the user for the device pointer array on the master control device, and triggers page switching through the operation instruction. Optionally, the page touch operation instruction is a drag input by the user on the device pointer array.

Based on FIG. 6, in a case that the page touch operation instruction is an operation instruction for the device pointer array, in response to the page touch operation instruction, each device pointer in the device pointer array is moved along the operation direction in the page touch operation instruction by N page nodes according to their arrangement order. Then, an application page corresponding to a page node pointed to by a device pointer of the master control device is displayed on the master control device after the page node movement, and page data corresponding to the page nodes pointed to by the device pointers after the page node movement is sent to the other first electronic devices (other slave control devices) excluding the master control device.

In Example 8, Device 1 (master controller) receives a drag input that is performed on the device pointer array from the user, and the device pointer data slides left or right along the page control linked list with the user drag, as shown in FIG. 20.

Then, Device 1 senses, at the front end, the amplitude of the user dragging the device pointer on the screen, that is, the number of page nodes by which all device pointers have moved left or right in the page control linked list after the sliding operation, where the number of page nodes by which the device points have moved can be recorded as n.

Then, Device 1 sends the page data correspondingly stored in the page nodes pointed to by the device pointers after the page node movement to the slave controllers (Device 1 and Device 2), and the slave controllers display the pages corresponding to the received page data on their front ends.

Finally, Device 1 displays the page data corresponding to the page node pointed to by the device pointer corresponding to the master controller after the page node movement on the front end.

In this embodiment, through sliding of the device pointer array on the master controller, the function of switching pages on the master controller and slave controllers is implemented, providing users with a new device control experience.

Certainly, when the user does not require split-screen application display across multiple electronic devices, the cascading control among multiple devices can be released. In an optional embodiment, the embodiments of this application may further include:
receiving a fourth input that is performed on an exit button from the user;
where the exit button is illustrated in FIG. 6; and
in response to the fourth input, releasing the communication connection among the N first electronic devices.

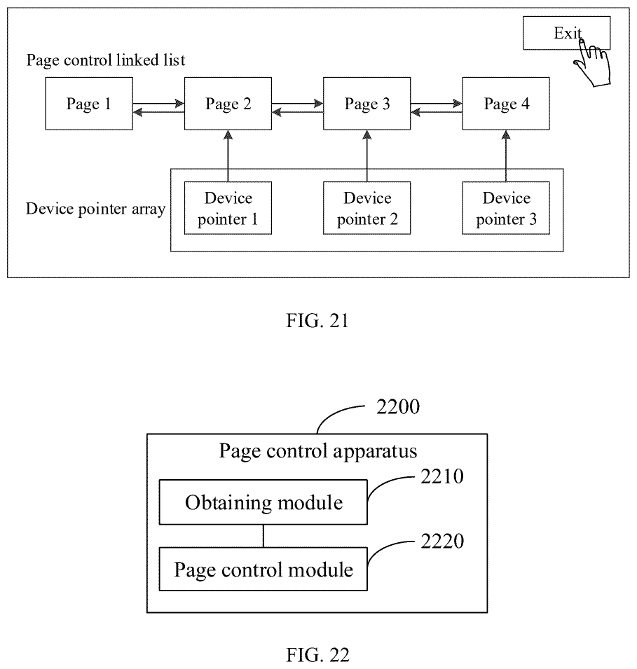

In Example 9, the master controller receives a tap input that is performed on the exit button from the user, as shown in FIG. 21. The master controller sends an instruction for exiting the second application (the news application described above) to the slave controllers via the Bluetooth control connection. After receiving the instruction, the slave controllers display the desktop (main page) on the front end and close the application process in the background.

Then, the master controller sends an instruction for shutting down the Bluetooth connection to the slave controllers. After receiving the instruction, the slave controllers shut down the Bluetooth connection. Finally, the master controller shuts down the Bluetooth connection and exits the device cascading control state.

This embodiment enables the user to exit the device cascading state and return to normal usage mode.

It should be noted that the method of this application can be applied between phones, between a phone and a tablet, or between a phone and a vehicle.

The page control method provided in the embodiments of this application may be executed by a page control apparatus. In the embodiments of this application, the page control apparatus executing the page control method is taken as an example to describe the page control apparatus provided in the embodiments of this application.

FIG. 22 shows a page control apparatus according to an embodiment of this application. The apparatus 2200 may include:
an obtaining module 2210 configured to obtain a page touch operation instruction; and
a page control module 2220 configured to control, in response to the page touch operation instruction, display of a target page triggered by the page touch operation instruction on a target electronic device among N first electronic devices based on an indication state of a device pointer array, where the device pointer array includes device pointers of the N first electronic devices, each device pointer is used to indicate a display page of a corresponding first electronic device, and Nis a positive integer greater than 1.

Optionally, the page control module 2220 includes:
a first obtaining unit configured to: in a case that the page touch operation instruction is an add application page instruction, obtain, in response to the add application page instruction, a new application page corresponding to the add application page instruction; and
a first page control unit configured to control display of the new application page on the target electronic device based on an indication state of a first device pointer corresponding to a second electronic device that generates the add application page instruction and an arrangement order of the device pointers of the N first electronic devices, where the second electronic device is one of the N first electronic devices.

Optionally, the first page control unit is specifically configured to:
in a case that the first device pointer indicates that a front-end display page of the second electronic device is a first application page, and that a second device pointer ranked after the first device pointer exists in the device pointer array, determine a first electronic device corresponding to the second device pointer as the target electronic device, where the second device pointer indicates that a front-end display page of the target electronic device is a main page or a second application page, and the second application page is an application page of a same level as the new application page; and
control display of the new application page on the target electronic device, where the new application page is a next-level application page of the first application page.

Optionally, the first page control unit is specifically configured to:
in a case that the first device pointer indicates that a front-end display page of the second electronic device is a first application page, and that the first device pointer is a last device pointer in the device pointer array, determine the second electronic device as the target electronic device; and
control display of the new application page on the target electronic device, where the new application page is a next-level application page of the first application page.

Optionally, the page control apparatus 2200 in the embodiments of this application further includes:
a first update module configured to update the indication state of the device pointer array; and
a second update module configured to update, based on the updated indication state of the device pointer array, a front-end display page of an electronic device to be updated.

Optionally, the page control module 2220 includes:
a first processing unit configured to, in a case that the page touch operation instruction is a delete application page instruction, determine a third application page corresponding to the delete application page instruction;
a second processing unit configured to update indication states of a third device pointer and all device pointers ranked after the third device pointer, obtain the updated indication states of the third device pointer and all device pointers ranked after the third device pointer, and determine first electronic devices corresponding to the device pointers with the updated indication states as the target electronic devices, where the third device pointer is a device pointer corresponding to the third application page;
a second page control unit configured to control, based on the updated indication states of all device pointers ranked after the third device pointer, display of the main page on the target electronic devices corresponding to the device pointers;
a third page control unit configured to, in a case that the third application page is an application home page, control, based on the updated indication state of the third device pointer, display of the main page on a target electronic device corresponding to the third device pointer; and
a fourth page control unit configured to, in a case that the third application page is not an application home page, control, based on the updated indication state of the third device pointer, display of a previous-level application page of the third application page on the target electronic device corresponding to the third device pointer.

Optionally, the page control module 2220 includes:
a third update unit configured to, in a case that the page touch operation instruction is an operation instruction for the device pointer array, update, in response to the page touch operation instruction, the indication state of the device pointer array according to an operation direction in the page touch operation instruction; and
a fourth update unit configured to update, based on the updated indication state of the device pointer array, front-end display pages of all the first electronic devices.

The page control apparatus in the embodiments of this application obtains a page touch operation instruction through the first electronic device; controls, in response to the page touch operation instruction, display of a target page triggered by the page touch operation instruction on a target electronic device among N first electronic devices based on an indication state of a device pointer array, where the device pointer array includes device pointers of the N first electronic devices, each device pointer is used to indicate a display page of a corresponding first electronic device, and N is a positive integer greater than 1. This can implement split-screen application display across multiple electronic devices, satisfying user requirements for split-screen functionality across multiple devices.

The page control apparatus in the embodiments of this application may be an electronic device or a component in an electronic device, such as an integrated circuit or a chip. The electronic device may be a terminal or other devices besides a terminal. For example, the electronic device may be a mobile phone, a tablet computer, a notebook computer, a palmtop computer, a vehicle-mounted electronic device, a mobile internet device (MID), an augmented reality (AR)/virtual reality (VR) device, a robot, a wearable device, an ultra-mobile personal computer (UMPC), a netbook, or a personal digital assistant (PDA), or may be a network attached storage (NAS), a personal computer (PC), a television (TV), a teller machine, a self-service machine, or the like, which is not specifically limited in the embodiments of this application.

The page control apparatus in the embodiments of this application may be an apparatus having an operating system. The operating system may be an Android operating system, an iPhone operating system (iOS), or other possible operating systems, which is not specifically limited in the embodiments of this application.

The page control apparatus provided in the embodiments of this application can implement each process implemented by the method embodiments of FIG. 1 to FIG. 21. To avoid repetition, details are not repeated herein.

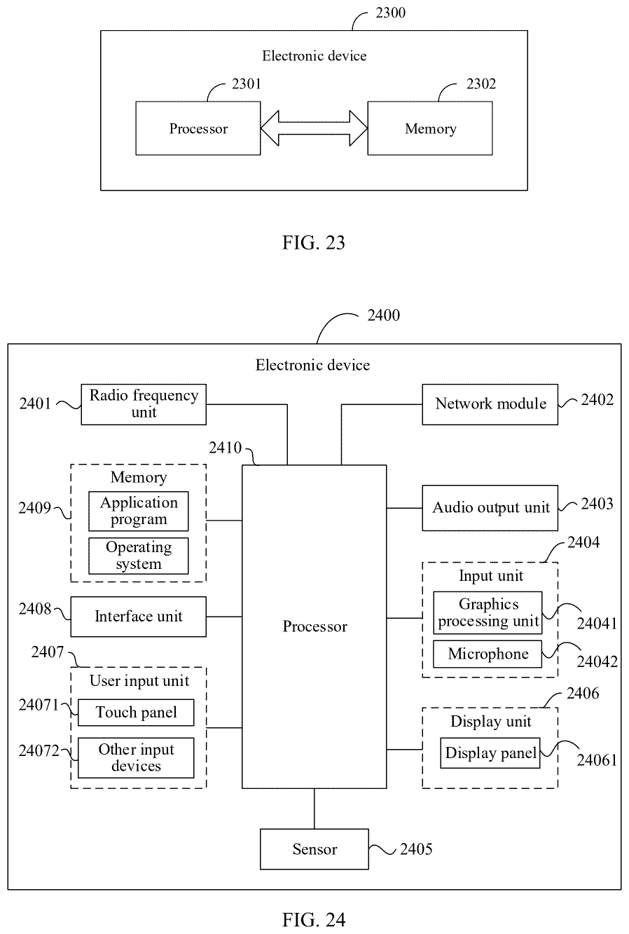

Optionally, as shown in FIG. 23, an embodiment of this application further provides an electronic device 2300, including a processor 2301 and a memory 2302. The memory 2302 stores a program or instructions capable of running on the processor 2301. When the program or instructions are executed by the processor 2301, each step of the above page control method embodiments is implemented, with the same technical effects achieved. To avoid repetition, details are not repeated herein.

It should be noted that the electronic device in the embodiments of this application includes the mobile electronic device and non-mobile electronic device described above.

FIG. 24 is a schematic diagram of a hardware structure of an electronic device implementing an embodiment of this application.

The electronic device 2400 includes but is not limited to components such as a radio frequency unit 2401, a network module 2402, an audio output unit 2403, an input unit 2404, a sensor 2405, a display unit 2406, a user input unit 2407, an interface unit 2408, a memory 2409, and a processor 2410.

Those skilled in the art can understand that the electronic device 2400 may further include a power source (such as a battery) for supplying power to each component, and the power source may be logically connected to the processor 2410 through a power management system, so as to implement functions such as charging and discharging management and power consumption through the power management system. The structure of the electronic device shown in FIG. 24 does not constitute a limitation on the electronic device, and the electronic device may include more or fewer components than shown in the figures, or combine some components, or have a different component arrangement, which is not repeated herein.

The processor 2410 is configured to: obtain a page touch operation instruction; and
control, in response to the page touch operation instruction, display of a target page triggered by the page touch operation instruction on a target electronic device among N first electronic devices based on an indication state of a device pointer array, where the device pointer array includes device pointers of the N first electronic devices, each device pointer is used to indicate a display page of a corresponding first electronic device, and N is a positive integer greater than 1.

The embodiment of this application can implement split-screen application display across multiple electronic devices, satisfying user requirements for split-screen functionality across multiple devices.

It should be understood that in the embodiments of this application, the input unit 2404 may include a graphics processing unit (GPU) 24041 and a microphone 24042, where the graphics processing unit 24041 processes image data of still pictures or videos obtained by an image capture apparatus (such as a camera) in video capture mode or image capture mode. The display unit 2406 may include a display panel 24061, where the display panel 24061 may be configured in the form of a liquid crystal display, an organic light-emitting diode, or the like. The user input unit 2407 includes at least one of a touch panel 24071 and other input devices 24072. The touch panel 24071 is also referred to as a touchscreen. The touch panel 24071 may include two parts: a touch detection apparatus and a touch controller. The other input devices 24072 may include, but are not limited to, a physical keyboard, a function key (such as a volume control key or an on/off key), a trackball, a mouse, and a joystick, which are not described herein.

The memory 2409 may be configured to store software programs and various data. The memory 2409 may mainly include a first storage area for storing programs or instructions and a second storage area for storing data, where the first storage area may store an operating system, applications or instructions required for at least one function (such as a sound play function or an image play function), and the like. Furthermore, the memory 2409 may include a volatile memory or a non-volatile memory, or the memory 2409 may include both volatile and non-volatile memories. The non-volatile memory may be a read-only memory (ROM), a programmable ROM (Programmable ROM, PROM), an erasable PROM (Erasable PROM, EPROM), an electrically erasable PROM (Electrically EPROM, EEPROM), or a flash memory. The volatile memory may be a random access memory (RAM), a static RAM (Static RAM, SRAM), a dynamic RAM (Dynamic RAM, DRAM), a synchronous DRAM (Synchronous DRAM, SDRAM), a double data rate SDRAM (Double Data Rate SDRAM, DDRSDRAM), an enhanced SDRAM (Enhanced SDRAM, ESDRAM), a synch link DRAM (Synch link DRAM, SLDRAM), or a direct Rambus RAM (Direct Rambus RAM, DRRAM). The memory 2409 in the embodiments of this application includes, but is not limited to, these and any other suitable types of memory.

The processor 2410 may include one or more processing units. Optionally, the processor 2410 integrates an application processor and a modem processor, where the application processor mainly handles operations related to the operating system, user interface, and application programs, and the modem processor, such as a baseband processor, mainly handles wireless communication signals. It can be understood that the modem processor may alternatively not be integrated into the processor 2410.

Optionally, the processor 2410 is further configured to:
in a case that the page touch operation instruction is an add application page instruction, obtain, in response to the add application page instruction, a new application page corresponding to the add application page instruction; and
control display of the new application page on the target electronic device based on an indication state of a first device pointer corresponding to a second electronic device that generates the add application page instruction and an arrangement order of the device pointers of the N first electronic devices, where the second electronic device is one of the N first electronic devices.

Optionally, the processor 2410 is further configured to:
in a case that the first device pointer indicates that a front-end display page of the second electronic device is a first application page, and that a second device pointer ranked after the first device pointer exists in the device pointer array, determine a first electronic device corresponding to the second device pointer as the target electronic device, where the second device pointer indicates that a front-end display page of the target electronic device is a main page or a second application page, and the second application page is an application page of a same level as the new application page; and
control display of the new application page on the target electronic device, where the new application page is a next-level application page of the first application page.

Optionally, the processor 2410 is further configured to:
in a case that the first device pointer indicates that a front-end display page of the second electronic device is a first application page, and that the first device pointer is a last device pointer in the device pointer array, determine the second electronic device as the target electronic device; and
control display of the new application page on the target electronic device, where the new application page is a next-level application page of the first application page.

Optionally, the processor 2410 is further configured to:
update the indication state of the device pointer array; and
update, based on the updated indication state of the device pointer array, a front-end display page of an electronic device to be updated.

Optionally, the processor 2410 is further configured to:
in a case that the page touch operation instruction is a delete application page instruction, determine a third application page corresponding to the delete application page instruction;
update indication states of a third device pointer and all device pointers ranked after the third device pointer, obtain the updated indication states of the third device pointer and all device pointers ranked after the third device pointer, and determine the first electronic devices corresponding to the device pointers with the updated indication states as the target electronic devices, where the third device pointer is a device pointer corresponding to the third application page;
control, based on the updated indication states of all device pointers ranked after the third device pointer, display of the main page on the target electronic devices corresponding to the device pointers; and
in a case that the third application page is an application home page, control, based on the updated indication state of the third device pointer, display of the main page on the target electronic device corresponding to the third device pointer; or
in a case that the third application page is not an application home page, control, based on the updated indication state of the third device pointer, display of a previous-level application page of the third application page on the target electronic device corresponding to the third device pointer.

Optionally, the processor 2410 is further configured to:
in a case that the page touch operation instruction is an operation instruction for the device pointer array, update, in response to the page touch operation instruction, the indication state of the device pointer array according to an operation direction in the page touch operation instruction; and
update, based on the updated indication state of the device pointer array, the front-end display pages of the first electronic devices.

An embodiment of this application further provides a readable storage medium, where a program or instructions are stored on the readable storage medium. When the program or instructions are executed by a processor, each process of the above page control method embodiments is implemented, with the same technical effects achieved. To avoid repetition, details are not repeated herein.

The processor is the processor in the electronic device described in the above embodiments. The readable storage medium includes a computer-readable storage medium, such as a computer read-only memory ROM, a random access memory RAM, a magnetic disk, or an optical disk.

An embodiment of this application further provides a chip, where the chip includes a processor and a communication interface, the communication interface is coupled to the processor, and the processor is configured to run a program or instructions to implement each process of the above page control method embodiments, with the same technical effects achieved. To avoid repetition, details are not repeated herein.

It should be understood that the chip mentioned in the embodiments of this application may also be referred to as a system-on-chip, a system chip, a chip system, or a system on chip.

An embodiment of this application provides a computer program product, where the program product is stored in a storage medium, and the program product is executed by at least one processor to implement each process of the above page control method embodiments, with the same technical effects achieved. To avoid repetition, details are not repeated herein.

It should be noted that, in this document, the terms “include”, “comprise”, or any other variants thereof are intended to cover a non-exclusive inclusion, such that a process, method, article, or apparatus that includes a series of elements not only includes those elements but also includes other elements not explicitly listed, or includes elements inherent to such a process, method, article, or apparatus. Without further limitation, an element defined by the phrase “including a . . . ” does not exclude the presence of other identical elements in the process, method, article, or apparatus that includes the element. Furthermore, it should be noted that the scope of the methods and apparatuses in the embodiments of this application is not limited to performing functions in the order shown or discussed, but may also include performing functions in a substantially simultaneous manner or in a reverse order according to the functions involved. For example, the described methods may be performed in an order different from that described, and various steps may be added, omitted, or combined. Additionally, features described with reference to certain examples may be combined in other examples.

Through the description of the above embodiments, those skilled in the art can clearly understand that the above embodiment methods can be implemented by means of software plus a necessary general hardware platform, and of course, can also be implemented by hardware, but in many cases, the former is a better implementation. Based on this understanding, the technical solution of this application, in essence or the part contributing to the related art, can be embodied in the form of a computer software product, which is stored in a storage medium (such as a ROM/RAM, a magnetic disk, or an optical disc) and includes several instructions to enable a terminal (which may be a mobile phone, a computer, a server, a network device, or the like) to execute the methods described in the various embodiments of this application.

The embodiments of this application have been described above with reference to the drawings, but this application is not limited to the specific embodiments described above. The specific embodiments described above are merely illustrative and not restrictive. Under the inspiration of this application, those of ordinary skill in the art can make many forms without departing from the purpose of this application and the scope protected by the claims, all of which fall within the protection of this application.

What is claimed is:

1. A page control method, comprising:
obtaining a page touch operation instruction; and
controlling, in response to the page touch operation instruction, display of a target page triggered by the page touch operation instruction on a target electronic device among N first electronic devices based on an indication state of a device pointer array, wherein the device pointer array comprises device pointers of the N first electronic devices, each device pointer is used to indicate a display page of a corresponding first electronic device, and N is a positive integer greater than 1.

2. The method according to claim 1, wherein the controlling, in response to the page touch operation instruction, display of a target page triggered by the page touch operation instruction on a target electronic device among N first electronic devices based on an indication state of a device pointer array comprises:
in a case that the page touch operation instruction is an add application page instruction, obtaining, in response to the add application page instruction, a new application page corresponding to the add application page instruction; and
controlling display of the new application page on the target electronic device based on an indication state of a first device pointer corresponding to a second electronic device that generates the add application page instruction and an arrangement order of the device pointers of the N first electronic devices, wherein the second electronic device is one of the N first electronic devices.

3. The method according to claim 2, wherein the controlling display of the new application page on the target electronic device based on an indication state of a first device pointer corresponding to a second electronic device that generates the add application page instruction and an arrangement order of the device pointers of the N first electronic devices comprises:
in a case that the first device pointer indicates that a front-end display page of the second electronic device is a first application page, and a second device pointer ranked after the first device pointer exists in the device pointer array, determining a first electronic device corresponding to the second device pointer as the target electronic device, wherein the second device pointer indicates that a front-end display page of the target electronic device is a main page or a second application page, and the second application page is an application page of a same level as the new application page; and
controlling display of the new application page on the target electronic device, wherein the new application page is a next-level application page of the first application page.

4. The method according to claim 2, wherein the controlling display of the new application page on the target electronic device based on an indication state of a first device pointer corresponding to a second electronic device that generates the add application page instruction and an arrangement order of the device pointers of the N first electronic devices comprises:
in a case that the first device pointer indicates that a front-end display page of the second electronic device is a first application page, and that the first device pointer is a last device pointer in the device pointer array, determining the second electronic device as the target electronic device; and
controlling display of the new application page on the target electronic device, wherein the new application page is a next-level application page of the first application page.

5. The method according to claim 2, wherein after the controlling display of the new application page on the target electronic device based on an indication state of a first device pointer corresponding to a second electronic device that generates the add application page instruction and an arrangement order of the device pointers of the N first electronic devices, the method further comprises:
updating the indication state of the device pointer array; and
updating, based on the updated indication state of the device pointer array, a front-end display page of an electronic device to be updated.

6. The method according to claim 1, wherein the controlling, in response to the page touch operation instruction, display of a target page triggered by the page touch operation instruction on a target electronic device among N first electronic devices based on an indication state of a device pointer array comprises:
in a case that the page touch operation instruction is a delete application page instruction, determining a third application page corresponding to the delete application page instruction;
updating indication states of a third device pointer and all device pointers ranked after the third device pointer, obtaining the updated indication states of the third device pointer and all device pointers ranked after the third device pointer, and determining first electronic devices corresponding to the device pointers with the updated indication states as the target electronic devices, wherein the third device pointer is a device pointer corresponding to the third application page;
controlling, based on the updated indication states of all device pointers ranked after the third device pointer, display of a main page on the respective target electronic devices corresponding to the device pointers; and
in a case that the third application page is an application home page, controlling, based on the updated indication state of the third device pointer, display of the main page on the target electronic device corresponding to the third device pointer; or
in a case that the third application page is not an application home page, controlling, based on the updated indication state of the third device pointer, display of a previous-level application page of the third application page on the target electronic device corresponding to the third device pointer.

7. The method according to claim 1, wherein the controlling, in response to the page touch operation instruction, display of a target page triggered by the page touch operation instruction on a target electronic device among N first electronic devices based on an indication state of a device pointer array comprises:
in a case that the page touch operation instruction is an operation instruction for the device pointer array, updating, in response to the page touch operation instruction, the indication state of the device pointer array according to an operation direction in the page touch operation instruction; and
updating, based on the updated indication state of the device pointer array, front-end display pages of the first electronic devices.

8. An electronic device, comprising a processor and a memory, wherein the memory stores a program or an instruction capable of running on the processor, wherein the program or the instruction, when executed by the processor, causes the electronic device to perform:
obtaining a page touch operation instruction; and
controlling, in response to the page touch operation instruction, display of a target page triggered by the page touch operation instruction on a target electronic device among N first electronic devices based on an indication state of a device pointer array, wherein the device pointer array comprises device pointers of the N first electronic devices, each device pointer is used to indicate a display page of a corresponding first electronic device, and N is a positive integer greater than 1.

9. The electronic device according to claim 8, wherein when controlling, in response to the page touch operation instruction, display of a target page triggered by the page touch operation instruction on a target electronic device among N first electronic devices based on an indication state of a device pointer array, the program or the instruction, when executed by the processor, causes the electronic device to perform:
in a case that the page touch operation instruction is an add application page instruction, obtaining, in response to the add application page instruction, a new application page corresponding to the add application page instruction; and
controlling display of the new application page on the target electronic device based on an indication state of a first device pointer corresponding to a second electronic device that generates the add application page instruction and an arrangement order of the device pointers of the N first electronic devices, wherein the second electronic device is one of the N first electronic devices.

10. The electronic device according to claim 9, wherein when controlling display of the new application page on the target electronic device based on an indication state of a first device pointer corresponding to a second electronic device that generates the add application page instruction and an arrangement order of the device pointers of the N first electronic devices, the program or the instruction, when executed by the processor, causes the electronic device to perform:
in a case that the first device pointer indicates that a front-end display page of the second electronic device is a first application page, and a second device pointer ranked after the first device pointer exists in the device pointer array, determining a first electronic device corresponding to the second device pointer as the target electronic device, wherein the second device pointer indicates that a front-end display page of the target electronic device is a main page or a second application page, and the second application page is an application page of a same level as the new application page; and
controlling display of the new application page on the target electronic device, wherein the new application page is a next-level application page of the first application page.

11. The electronic device according to claim 9, wherein when controlling display of the new application page on the target electronic device based on an indication state of a first device pointer corresponding to a second electronic device that generates the add application page instruction and an arrangement order of the device pointers of the N first electronic devices, the program or the instruction, when executed by the processor, causes the electronic device to perform:
in a case that the first device pointer indicates that a front-end display page of the second electronic device is a first application page, and that the first device pointer is a last device pointer in the device pointer array, determining the second electronic device as the target electronic device; and
controlling display of the new application page on the target electronic device, wherein the new application page is a next-level application page of the first application page.

12. The electronic device according to claim 9, wherein after controlling display of the new application page on the target electronic device based on an indication state of a first device pointer corresponding to a second electronic device that generates the add application page instruction and an arrangement order of the device pointers of the N first electronic devices, the program or the instruction, when executed by the processor, causes the electronic device to further perform:
updating the indication state of the device pointer array; and
updating, based on the updated indication state of the device pointer array, a front-end display page of an electronic device to be updated.

13. The electronic device according to claim 8, wherein when controlling, in response to the page touch operation instruction, display of a target page triggered by the page touch operation instruction on a target electronic device among N first electronic devices based on an indication state of a device pointer array, the program or the instruction, when executed by the processor, causes the electronic device to perform:
in a case that the page touch operation instruction is a delete application page instruction, determining a third application page corresponding to the delete application page instruction;
updating indication states of a third device pointer and all device pointers ranked after the third device pointer, obtaining the updated indication states of the third device pointer and all device pointers ranked after the third device pointer, and determining first electronic devices corresponding to the device pointers with the updated indication states as the target electronic devices, wherein the third device pointer is a device pointer corresponding to the third application page;
controlling, based on the updated indication states of all device pointers ranked after the third device pointer, display of a main page on the respective target electronic devices corresponding to the device pointers; and
in a case that the third application page is an application home page, controlling, based on the updated indication state of the third device pointer, display of the main page on the target electronic device corresponding to the third device pointer; or
in a case that the third application page is not an application home page, controlling, based on the updated indication state of the third device pointer, display of a previous-level application page of the third application page on the target electronic device corresponding to the third device pointer.

14. The electronic device according to claim 8, wherein when controlling, in response to the page touch operation instruction, display of a target page triggered by the page touch operation instruction on a target electronic device among N first electronic devices based on an indication state of a device pointer array, the program or the instruction, when executed by the processor, causes the electronic device to perform:
in a case that the page touch operation instruction is an operation instruction for the device pointer array, updating, in response to the page touch operation instruction, the indication state of the device pointer array according to an operation direction in the page touch operation instruction; and
updating, based on the updated indication state of the device pointer array, front-end display pages of the first electronic devices.

15. A non-transitory readable storage medium, wherein a program or an instruction are stored on the readable storage medium, wherein the program or the instruction, when executed by a processor of an electronic device, causes the electronic device to perform:
obtaining a page touch operation instruction; and
controlling, in response to the page touch operation instruction, display of a target page triggered by the page touch operation instruction on a target electronic device among N first electronic devices based on an indication state of a device pointer array, wherein the device pointer array comprises device pointers of the N first electronic devices, each device pointer is used to indicate a display page of a corresponding first electronic device, and N is a positive integer greater than 1.

16. The non-transitory readable storage medium according to claim 15, wherein when controlling, in response to the page touch operation instruction, display of a target page triggered by the page touch operation instruction on a target electronic device among N first electronic devices based on an indication state of a device pointer array, the program or the instruction, when executed by the processor of the electronic device, causes the electronic device to perform:
in a case that the page touch operation instruction is an add application page instruction, obtaining, in response to the add application page instruction, a new application page corresponding to the add application page instruction; and
controlling display of the new application page on the target electronic device based on an indication state of a first device pointer corresponding to a second electronic device that generates the add application page instruction and an arrangement order of the device pointers of the N first electronic devices, wherein the second electronic device is one of the N first electronic devices.

17. The non-transitory readable storage medium according to claim 16, wherein when controlling display of the new application page on the target electronic device based on an indication state of a first device pointer corresponding to a second electronic device that generates the add application page instruction and an arrangement order of the device pointers of the N first electronic devices, the program or the instruction, when executed by the processor of the electronic device, causes the electronic device to perform:
in a case that the first device pointer indicates that a front-end display page of the second electronic device is a first application page, and a second device pointer ranked after the first device pointer exists in the device pointer array, determining a first electronic device corresponding to the second device pointer as the target electronic device, wherein the second device pointer indicates that a front-end display page of the target electronic device is a main page or a second application page, and the second application page is an application page of a same level as the new application page; and
controlling display of the new application page on the target electronic device, wherein the new application page is a next-level application page of the first application page.

18. The non-transitory readable storage medium according to claim 16, wherein when controlling display of the new application page on the target electronic device based on an indication state of a first device pointer corresponding to a second electronic device that generates the add application page instruction and an arrangement order of the device pointers of the N first electronic devices, the program or the instruction, when executed by the processor of the electronic device, causes the electronic device to perform:
in a case that the first device pointer indicates that a front-end display page of the second electronic device is a first application page, and that the first device pointer is a last device pointer in the device pointer array, determining the second electronic device as the target electronic device; and
controlling display of the new application page on the target electronic device, wherein the new application page is a next-level application page of the first application page.

19. A chip, wherein the chip comprises a processor and a communication interface, the communication interface is coupled to the processor, and the processor is configured to run a program or instruction to implement the method according to claim 1.

20. A computer program product, wherein the program product is stored in a non-volatile storage medium, and the program product is executed by at least one processor to implement the method according to claim 1.
